(19) United States
(12) Patent Application Publication
(10) Pub. No.: US 2008/0098552 A1
(43) Pub. Date: May 1, 2008

(54) Filler Material Finishing Tool

(76) Inventor: John Wayne Kleinhammer, Cayucos, CA (US)

Correspondence Address: WILSON DANIEL SWAYZE, JR., 3804 CLEARWATER CT., PLANO, TX, 75025, US

(21) Appl. No.: 11/968,689

(22) Filed: Jan. 3, 2008

Related U.S. Application Data
(63) Continuation-in-part of application No. 11/296,838, filed on Dec. 6, 2005.

(51) Int. Cl. B05C 17/10

(52) U.S. Cl. 15/235.7

(57) ABSTRACT

A hand held tool comprised of an elongated triangular shaped elastomeric applicator tool (20) for spreading, smoothing and feathering filler material which can be utilized with a handle (30).

### BACKGROUND OF THE INVENTION

1. Field of the Invention

This invention relates to a hand held devices and more particularly to a handheld device being utilized to smooth and feather filler material.

2. Background of the Invention

Home improvement and paint stores commonly supply customers with filler material to improve the appearance of their work. Such filler material is used around door trim, windows, baseboard, tubs, showers, sinks, imperfections in walls, corners and other areas where professional finished appearance and/or sealing is desirable. Originally filler material was commonly applied with one's finger, a stick, a spoon etc. Thereafter, users created several types of devices to accomplish the task. Some devices are used in conjunction with a caulking gun. Other devices are hand held but have various limitations. An effective tool to smooth and feather filler material, accommodate varying angles of intersection and irregular surfaces producing a professional appearance would be beneficial.

Several devices have been proposed, for example U.S. Pat. No. 6,305,926 B1 issued to Ray on Oct. 21, 2001. The Ray device is placed on a finger to smooth filler material, care must be taken not to touch other areas where depositing filler material is undesirable or the device should be removed from one's finger and when use is again desired it will have to be re-placed on one's finger. U.S. Pat. No. 6,219,878 issued to Dewberry on Apr. 24, 2001 and U.S. Pat. No. 4,586,890 issued to Marchbanks necessitates excessive caulking to be applied for the tool to function properly. Both tools are designed to collect excess caulking resulting in waste and the necessity to clean and remove excess caulking from the tool. U.S. Pat. No. 5,792,489 issued to Liberman on Aug. 11, 1998 has a plethora of parts making it expensive to manufacture and difficult to clean. U.S. Pat. No. 5,675,860 issued to Campbell on any Oct. 14, 1997 has limited flexibility as only the rim margin is formed of a flexible, resilient material around a handle; obtuse and acute joints would be difficult to apply filler material.

### BACKGROUND OF THE INVENTION—OBJECTS AND ADVANTAGES

Accordingly, several objects and advantages of the present invention are:
a) to provide a tool which spreads, smoothes and feathers filler material to attain a professional finish;
b) to provide a tool which smooth and feathers filler material into acute, oblique and perpendicular joints;
c) to provide a tool with flexibility enabling conformity to surface variations;
d) to provide a tool which can be utilized without a handle for use in limited work areas;
e) to provide a tool with minimal components.

Further objects and advantages are to provide a filler material finishing tool that can be easily, conveniently and reliably used by both skilled craftsmen and novices “do-it-yourselfers”. Still further objects and advantages will become apparent from a consideration of the drawings and ensuing description.

### SUMMARY OF THE INVENTION

A device to smooth and feather filler material may include an elastomeric first side wall, an elastomeric second side wall connected to the first side wall and a substantially triangular cross section shaped elastomeric front wall. The device will smooth and feather filler material when drawn over said filler material.

The device may include a handle coupled to the piece, and the device may be made from a material selected from the group consisting of rubber, vinyl, and foam.

The present invention may include a method of making a device to smooth and feather filler material, and the method may include the steps of providing an elastomeric first side wall, providing a elastomeric second side wall connected to the first side wall and providing a substantially triangular shaped elastomeric front section.

The device will smooth and feather filler material when drawn over said filler material when presented an angle of intersection of a joint that the device is capable of smoothing and feathering filler material when drawn over said filler material.

The present invention may include a caulk applicator which may include an elastomeric first side wall, an elastomeric second side wall connected to the first side wall and a substantially triangular shaped elastomeric front wall. The device that will smooth and feather filler material when drawn over the filler material and will cooperate with an angle of intersection of a joint that the piece is capable of smoothing and feathering filler material when drawn over said filler material.

The device may include the front wall being angled with respect to the first and second side walls, the front wall may be traverse to the longitudinal direction of the device.

### BRIEF DESCRIPTION OF THE DRAWINGS

### Drawing Figures

In the drawings, closely related figures have the same number but different alphabetic suffixes.

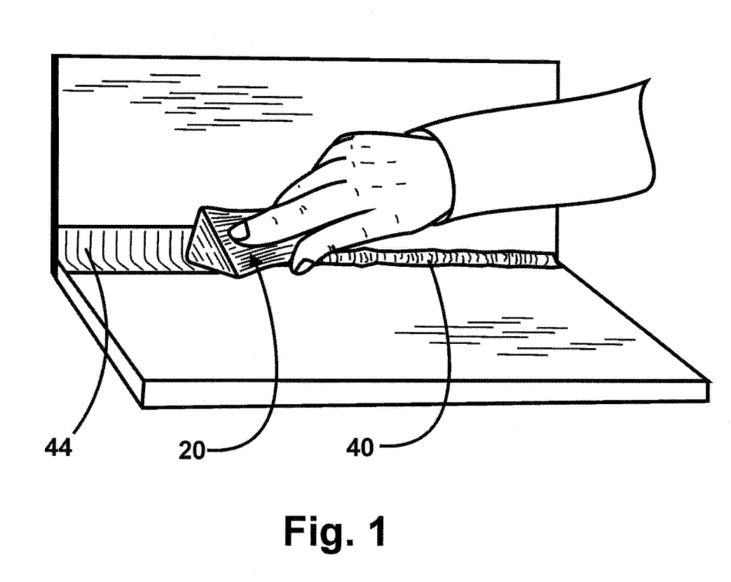

FIG. 1 is a perspective elevation of the tool in use.

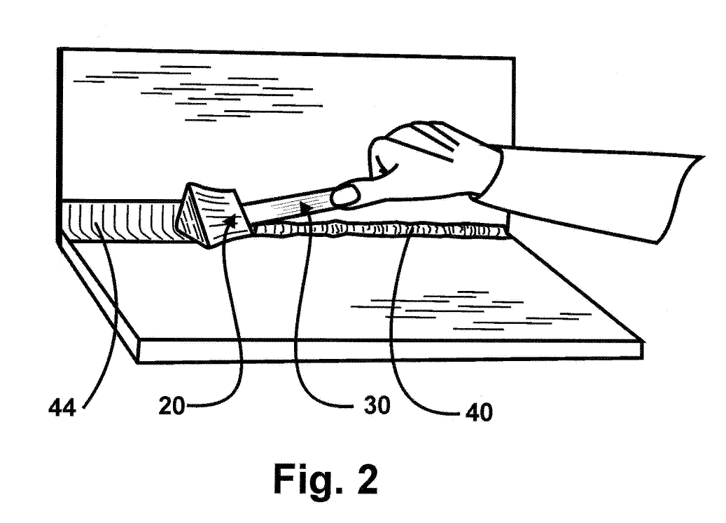

FIG. 2 is a perspective elevation of the tool in use with a handle.

FIG. 3 is a perspective elevation of the tool with a handle in use applying filler material to a wall and baseboard joint.

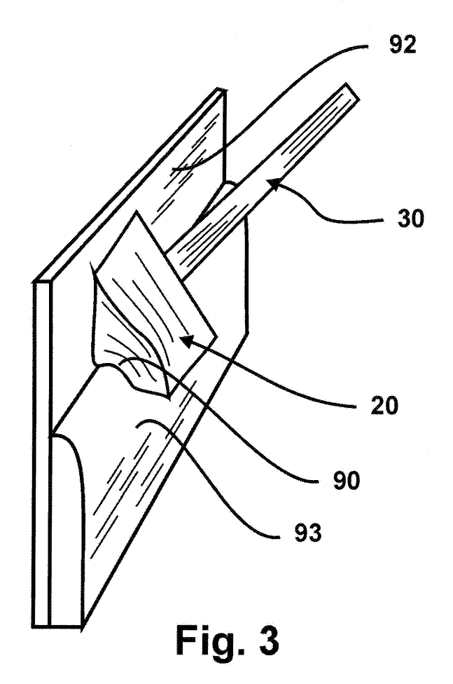

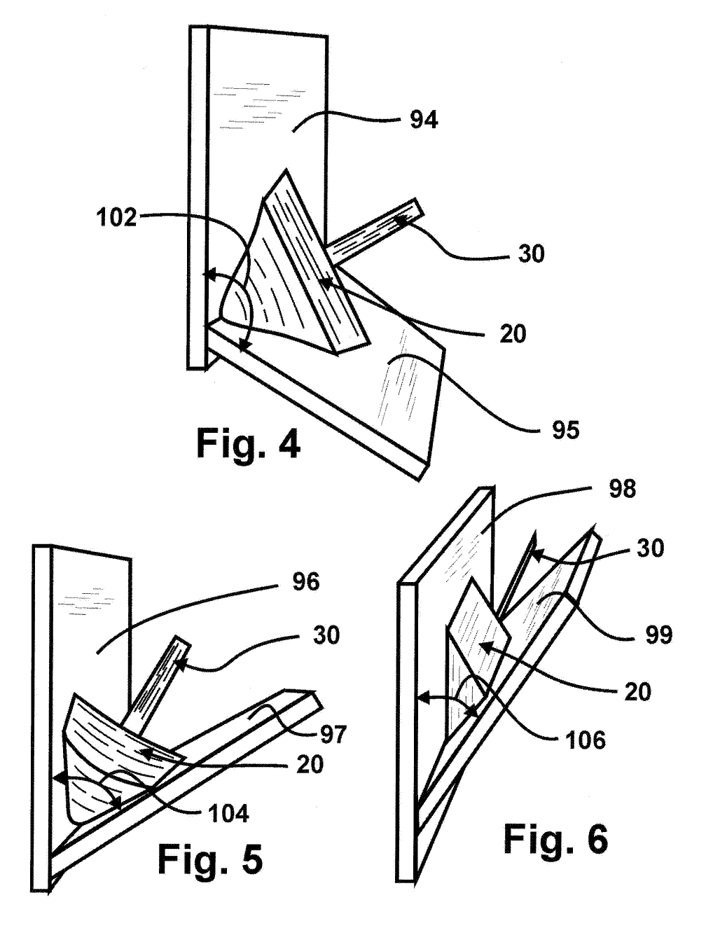

FIG. 4 is a perspective elevation of the tool with a handle attached inserted in an obtuse angle of intersection of two planar surfaces.

FIG. 5 is a perspective elevation of the tool with a handle attached inserted in an acute angle of intersection of two planar surfaces.

FIG. 6 is a perspective elevation of the tool with a handle attached inserted on edge in a small acute angle of intersection of two planar surfaces.

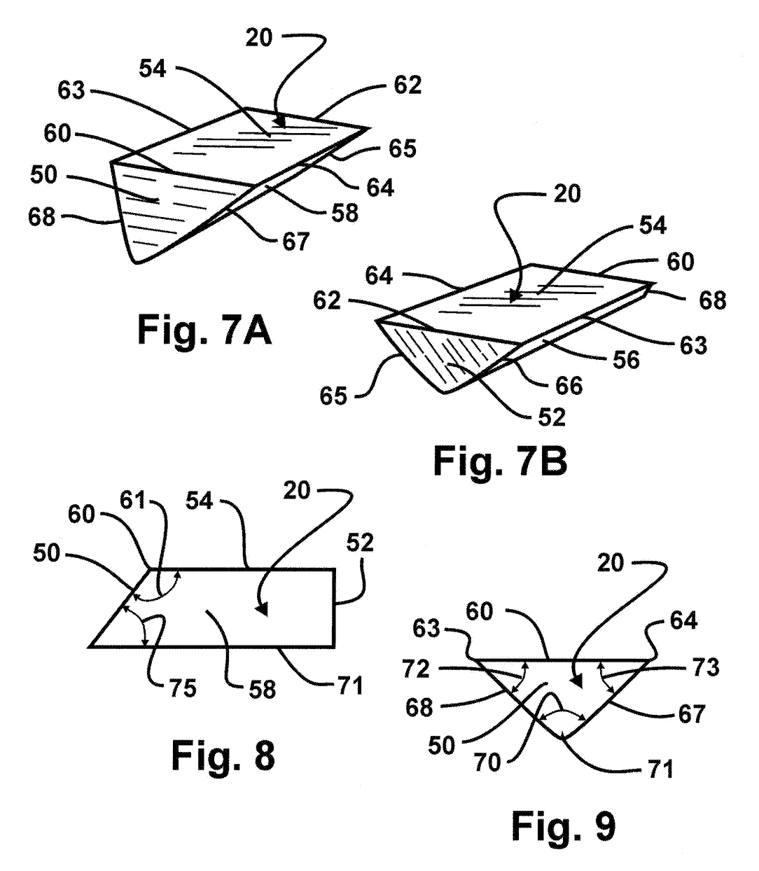

FIG. 7A is a perspective front elevation of the tool.

FIG. 7B is a perspective back elevation of the tool.

FIG. 8 is a side elevation of the tool.

FIG. 9 is a front elevation of the tool.

FIG. 10A is an exploded perspective elevation of the tool with a handle.

FIG. 10B is a perspective elevation of the tool with a handle.

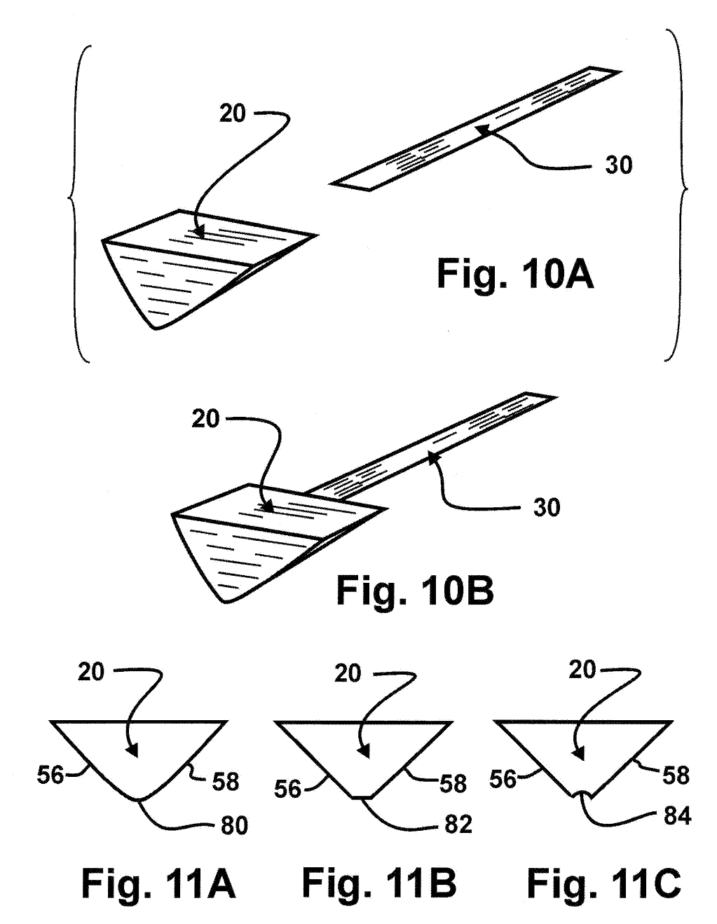

FIG. 11A is a front elevation of the tool to form a convex bead of filler material.

FIG. 11B is a front elevation of the tool to form a flat bead of filler material.

FIG. 11C is a front elevation of the tool to form a concave bead of filler material

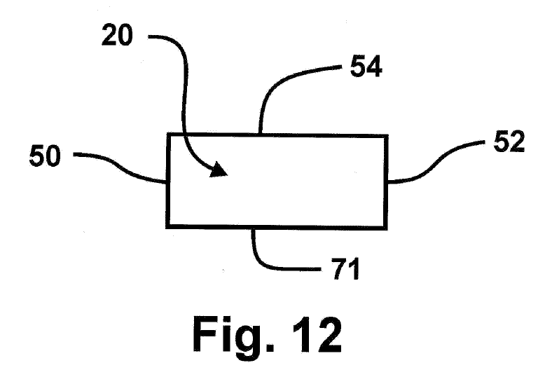

FIG. 12. Illustrates a side view of the tool in another embodiment of the present invention.

### REFERENCE NUMERALS IN DRAWINGS

20 filler material finishing tool
30 handle
40 filler material
44 smoothed filler material
50 front wall
52 back wall
54 top wall
56 side wall (wing)
58 side wall (wing)
60 front, top wall edge intersection
61 front wall angle of intersection with top wall
62 top, back wall intersection
63 edge formed by top, side wall intersection
64 edge formed by top, side wall intersection
65 edge formed by back, side wall intersection
66 edge formed by back, side wall intersection
67 edge formed by front, side wall intersection
68 edge formed by front, side wall intersection
70 side wall angle of intersection with vertex
71 side wall vertex
72 top and side wall angle of intersection
73 top and side wall angle of intersection
75 front wall angle of intersection with side wall vertex
80 convex vertex
82 flat vertex
84 concave vertex
90 tool side wall conforming to baseboard
92 planar surface
93 baseboard
94, 95 planar surfaces forming an obtuse joint
96, 97 planar surfaces forming an acute joint
98, 99 planar surfaces forming a small acute joint
102 oblique angle of intersection between two planar surfaces
104 acute angle of intersection between two planar surfaces
106 small acute angle of intersection between two planar surfaces

### DETAILED DESCRIPTION OF THE INVENTION

In accordance with the present invention, a filler material finishing tool includes an elongated substantially triangular cross sectional shaped elastomeric piece in which its sides act as wings to smooth, feather and expel air bubbles from filler material when drawn over said filler material which may be utilized with or without a handle.

### Description—FIGS. 1, 7, 8 and 9—Preferred Embodiment

A preferred embodiment of the filler material finishing tool of the present invention is illustrated in FIG. 1 (perspective view of use), FIG. 7A (perspective front elevation), FIG. 7B (perspective back elevation), FIG. 8 (side view) and FIG. 9 (front view). As seen in the drawings, the filler material finishing tool 20 includes an elongated substantially triangular cross sectional shape of predetermined length formed of elastomeric material. The elastomeric material may vary from very soft to firm enabling the filler material finishing tool 20 to comply and cooperate with the viscosity of filler material used. In the preferred embodiment, the filler material finishing tool 20 is formed of silicone. However the filler material finishing tool 20 can be formed from any of a wide variety of elastomeric material such as, rubber, vinyl, foam, etc or combination thereof. It can be manufactured by extrusion and cut to a predetermined length or injection molded.

Front wall 50 (FIGS. 7A and 8) is typically inclined at an acute angle 75 with respect to the side wall vertex 71 (FIG. 8) and at an obtuse angle 61 with respect to the top wall 54. FIG. 9 illustrates the front wall 50 forms a substantially triangular shaped surface traverse to the longitudinal axis of the tool 20, connecting to side walls by edges 67, 68 and top wall by edge 60. Front wall edges 67, 68 (FIG. 7A) connect the side walls 58, 56 (FIGS. 7A and 7B) to form the front edges of the side wall wings. Side wall wings 58, 56 form a trapezoidal surface, side wall wing 58 is bordered by edges 67, 64, 65, vertex 71, and side wall wing 56 is bordered by edges 68, 63, 66, vertex 71. Tool 20 is composed of elastomeric material enabling side walls 56, 58 to conform to the work area providing a smooth, feathered, and bubble free surface on the bead of caulking material. FIG. 12 illustrates a side view of the tool 20 and shows the front wall 50 perpendicular to the side wall vertex 71 of the tool 20. Top wall front edge 60 and side wall edges 67, 68 (FIG. 7A) join to form an acute angle 72, 73 (FIG. 9) forming front edges of the side wall wings 58, 56 (FIG. 7A, 7B). As shown in FIG. 9, side wall edges 67, 68 typically intersect forming an oblique angle 70 at vertex 71. FIG. 11A shows sides 56, 58 joining to form a rounded convex intersection 80 to smooth filler material in a concave shape. Back wall 52 (FIG. 7B) typically intersects top 54, and side walls 56 (FIG. 7B), 58 (FIG. 7A) at approximately right angle at edges (FIG. 7B) 62, 65 and 66. Front wall 50 and top wall 54 intersect at edge 60 (FIG. 8) and typically forms an obtuse angle 61.

### FIGS. 2, 3, 4, 5, 6, 7A, 10B, 10C—Additional Embodiments

Additional embodiments are shown in FIGS. 2, 3, 4, 5, 6 10A and 10B in which a handle 30 is attached to the filler material tool 20.

### FIGS. 10B, 10C—Alternative Embodiments

There are various possibilities with regard to the shape formed by the intersection of exterior surfaces forming edges of filler material finishing tool 20. Outer edges of tool 20 formed by the intersection of walls 50, 52, 54, 56 and 58 can be shaped in numerous configurations including sharp, beveled, concave and convex. FIG. 11B shows sides 56, 58 joining to form a substantially flat side wall intersection 82 to smooth filler material in a flat shape. FIG. 11C shows sides 56, 58 joining to form a concave side wall intersection 84 enabling a convex formation of filler material.

### Operation—FIGS. 1, 2, 3, 4, 5, 6

Typically filler material 40 is applied to a joint formed by the perpendicular intersection of two substantially planar surfaces, tool 20 (FIG. 1) is held by one's hand drawing it along the joint smoothing and feathering filler material 44. When the tool 20 is drawn over filler material 44, vertex 71 (FIG. 9) disperses filler material and bubbles outward, and sides 56, 58 (FIG. 7A, 7B, 9) smooth and feather it. Filler material finishing tool 20 as shown in FIG. 1 without a handle is well suited for use in confined working spaces.

FIG. 2 shows tool 20 in use with handle 30 attached. Handle 30 provides the user enhanced ease of use and control of tool 20.

In FIG. 3, tool 20 is shown inserted at the joint of a substantially planar surface 92 and baseboard 93, illustrating the ability of the tool's elastomeric properties to conform to irregular surfaces 90 by deforming to the irregular surface.

As shown in FIG. 4, the tool's 20 elastomeric properties enable it to conform to oblique angles of intersection 102 between two substantially planar surfaces 94, 95.

As shown in FIG. 5 the tool's 20 elastomeric composition enables it to conform to acute angles of intersection 104 between two substantially planar surfaces 96, 97 by deforming the tool or a portion of the tool.

In FIG. 6, the tool 20 is shown with edge 63 (FIG. 9) inserted in a small acute angle 106 (FIG. 6) of intersection between two substantially planar surfaces 98, 99 (FIG. 6). Both edges 63 and 64 (FIG. 9) can be utilized to apply filler material from opposite directions in a limited working space.

### Advantages

From the description above, a number of advantages of my filler material finishing tool become evident:

(a) The filler material finishing tool can be used without a handle to apply filler material in a confined space.

(b) The filler material finishing tool can be used with a handle when space permits providing superior control of the tool.

(c) The filler material finishing tool includes elastomeric material to provide the ability for the “do-it-yourselfer” or professional to attain smoothed, feathered and bubble free filler material with professional results.

(d) Elastomeric composition of the filler material finishing tool enables the user to apply filler material to substantially perpendicular joints and irregular joints surfaces such as that formed by baseboard and wall joint, obtuse joints, acute joints and small acute joints.

(e) Air bubbles are frequently found a bead of filler material, and if these air bubbles are allowed to remain, these air bubbles can result in an irregular surface being formed. The intersection of the two substantially planar side walls (wings) dispenses air bubbles outwards beyond the feathered edge of the filler material.

(f) The elongated substantially triangular cross-sectional shape of the tool provides side walls, which facilitate feathering while moving over the work area. Furthermore, the side walls provide the further benefit of dispensing bubbles outwards beyond the feathered edge.

(g) The flexible substantially planar side walls (wings) enable the user of the tool to adjust the tool to varying angles with respect to the filler material.

(h) As a result of the flexible nature and shape of the tool of the present invention, the user of the tool is not restricted to maintaining a single angle between the work surface and the tool. The elongated substantially triangular cross-sectional shape of the tool and the flexibility of the tool allow the user to vary the angle of the tool with respect to the work surface without diminishing the effectiveness of the tool.

(i) The elongated substantially cross sectional triangular shape provides side walls (wings) enabling the user of the tool to vary the angle at which the tool is held in relationship to the work, minimizing the excess caulking at the outer portions of the bead or at the center of the bead.

(j) If the user varies the angle of a prior art device, an irregular surface and excess caulking can result in the center or outer edges of the bead. Furthermore, air bubbles can be trapped within the bead.

### CONCLUSION, RAMIFICATIONS, AND SCOPE

Accordingly, the reader will see that the filler material finishing tool of this invention can be used to easily and conveniently apply filler material with professional results. Furthermore, the filler material finishing tool has the additional advantages in that:
it provides for smoothing and feathering filler material;
it disperses air bubbles beyond the feathered edge;
it provides a tool for applying filler material to joints formed with various intersecting angles;
it provides a tool for applying filler material in open and confined workspace.

Although the description above contains may specificities, these should not be construed as limiting the scope of the invention but as merely providing illustrations of some of the presently preferred embodiments of this invention. Many other variations are possible. For example the back of filler material finishing tool may intersect with the top and sides at other than a perpendicular angle; the front may join the vertex in an obtuse angle; sides, top, front and back may be formed by a curved surface, etc. It is to be understood, however, that there is no intention to limit the invention to the particular form disclosed. On the contrary, the intention is to cover all modifications, equivalences and alternative constructions falling within the spirit and scope of the invention. Thus the scope of the invention should be determined by the appended claims and their legal equivalents, rather than by the examples given.

What I claim as my invention is:

1. A device to smooth and feather filler material, said device comprising:
an elastomeric first side wall;
an elastomeric second side wall connected to the first side wall;
a substantially triangular cross section shaped elastomeric front wall,
wherein the device will smooth and feather filler material when drawn over said filler material.

2. The device to smooth and feather filler material of claim 1 wherein said device includes a handle coupled to the piece.

3. The device of claim 1, wherein said device is made from a material selected from the group consisting of rubber, vinyl, and foam.

4. A method of making a device to smooth and feather filler material, the method comprising:
providing an elastomeric first side wall;
providing a elastomeric second side wall connected to the first side wall;
providing a substantially triangular shaped elastomeric front section,
wherein the device will smooth and feather filler material when drawn over said filler material; and
providing an angle of intersection of a joint that the device is capable of smoothing and feathering filler material when drawn over said filler material.

5. A caulk applicator, comprising:
an elastomeric first side wall,
an elastomeric second side wall connected to the first side wall,
a substantially triangular shaped elastomeric front wall, wherein the device that will smooth and feather filler material when drawn over said filler material; and
an angle of intersection of a joint that the piece is capable of smoothing and feathering filler material when drawn over said filler material.

6. A device to smooth and feather filler material as in claim 1, wherein the front wall is angled with respect to the first and second side walls.

7. A device to smooth and feather filler material as in claim 1, wherein the front wall is traverse to the longitudinal direction of the device.
